(19) United States
(12) Patent Application Publication
(10) Pub. No.: US 2024/0232970 A1
(43) Pub. Date: Jul. 11, 2024

(54) SYSTEMS AND METHODS FOR ENSURING THAT ALLERGENS ARE NOT CONTAINED IN FOOD ORDERS PLACED WITH RESTAURANTS VIA MOBILE DEVICES

(71) Applicant: Daniel R Matus, Belize City (BZ)

(72) Inventor: Daniel R Matus, Belize City (BZ)

(21) Appl. No.: 18/133,669

(22) Filed: Apr. 12, 2023

Related U.S. Application Data
(60) Provisional application No. 63/329,912, filed on Apr. 12, 2022.

(51) Int. Cl. G06Q 30/0601; G06Q 50/12

(52) U.S. Cl. CPC G06Q 30/0621; G06Q 50/12

(57) ABSTRACT

An Aversion Alert system and method are provided that allow users to place food orders via personal computing devices (PCDs) such as smart phones in a way that eliminates or at least greatly reduces the possibility of allergens being present in the food orders. During a food ordering session, an Aversion Alert App running on the PCD searches for restaurants in a vicinity of the PCD that use a POS terminal configured to execute an Aversion Alert computer program. Restaurants found in the search that use the POS terminal configured to execute the Aversion Alert computer program are displayed on a display device of the PCD. Upon the PCD user selecting one of the displayed restaurants, only menu items of the selected restaurant that do not include the allergens listed in the profile information associated with the user are displayed on the display device of the PCD for ordering.

### CROSS-REFERENCE TO RELATED APPLICATIONS

The present application is a nonprovisional application that claims priority to a U.S. provisional application having Ser. No. 63/329,912, filed on Apr. 12, 2022, entitled “SYSTEMS AND METHODS FOR ENSURING THAT ALLERGENS ARE NOT CONTAINED IN FOOD ORDERS PLACED WITH RESTAURANTS VIA MOBILE DEVICES,” which is currently pending and which is incorporated by reference herein.

### TECHNICAL FIELD

The present disclosure relates to mobile devices, and more particularly, to systems and methods used by mobile devices and point-of-sale (POS) equipment located at restaurants to ensure that allergens are not contained in food orders.

### BACKGROUND

Mobile devices such as smartphones, for example, have a variety of software applications (Apps) residing on them that perform a variety of functions. These functions range from functions associated with useful day-to-day operations to leisure and entertainment. Some of the Apps are installed by the user after purchasing the mobile device, whereas others are installed in the factory. A variety of sensors are currently available on mobile devices to assist in performing these functions, such as, for example, Global Positioning System (GPS) sensors, accelerometer sensors, magnetometer sensors, gyroscope sensors, biometric sensors, various types of touch sensors and various types of optical sensors.

For all of these different types of sensors, a chip set of the mobile device has one or more processors that execute the Apps or other software and/or firmware that process the sensor outputs to cause the mobile device to perform various operations and/or to provide the user with audio, visual and/or mechanical output or feedback. For example, search Apps are known that use the output of a GPS sensor of the mobile device to search the geographical area in the vicinity of the mobile device for locations meeting search criteria entered by the user on the mobile device. These Apps present the user with choices that meet the search criteria and locations where the choices are available relative to the mobile device.

For example, it is not uncommon for mobile devices to execute an App that will cause a list of restaurants in the vicinity of the mobile device to be displayed to the user when the user enters the audio command “find restaurants near me”. In response to receiving such a command, the mobile device will display a list of restaurants and their geographical locations relative to (e.g., distance from) the mobile device. Apps are also available that allow mobile device users to order online and either pick up a to-go food order or have the food order delivered to a particular location.

While such Apps are available, however, they generally do not provide users with options to place food orders in a way that ensures that the food orders do not contain an allergen to which the user is allergic. One option is for the mobile device user to call the restaurant and inquire of the restaurant employee operating POS equipment of whether a food order contains one or more allergens, in which case the user may only order the food item if the employee ensures the user that the food item does not contain the allergen. Such manual operations are prone to human error and do not ensure that a food order delivered to the mobile device user is free of allergens to which the user may be allergic. For example, cross-contamination can occur in the kitchen due to the food preparer being unaware that the order will be served to a patron having a particular allergy, or the food order preparer may accidentally include an ingredient containing an allergen in a food order.

Some degree of automation or has been added to the food ordering process to assist the mobile device user in ordering food items that are free of allergens, but such processes are still prone to human error. U.S. Publ. Appl. No. 2021/0287312 to Yahata, et al. discloses a system in which a store terminal has a memory device that stores food dishes and their corresponding ingredients. A mobile device has a memory device that stores allergy information associated with the mobile device user. When the user of the mobile device enters the store, it communicates with the store terminal to acquire the menu information stored in the memory device of the store terminal. A processor of the mobile device performs an algorithm that analyzes the ingredients of the food dishes, extracts dishes on the menu that do not contain ingredients to which the user is allergic, and displays a recommended menu to the user of dishes that do not contain those ingredients.

While the systems and processes disclosed in Yahata, et al. may be somewhat effective at preventing the mobile device user from ordering a dish that contains an allergen to which the user is allergic, the system is still prone to human error, such as cross-contamination that can occur in the kitchen, an ingredient containing an allergen accidentally being included in a dish, etc. In addition, the systems and processes of Yahata, et al. only work when the mobile device user enters the store. Also, the systems and processes of Yahata, et al. only work for the particular user of the mobile device based on allergy information of the user stored in the memory device of the mobile device. In other words, if the user is a father who is accompanied by his daughter, the systems and processes do not ensure that the dish ordered for the daughter is free of allergens.

U.S. Pat. No. 10,476,973 to Mimassi allows a host to view a patron's information on a mobile POS device, such as a smartphone or tablet, communicated to the POS device from the patron's mobile device. The information communicated can include dietary requirements or allergies to help in serving the patron. This system is also prone to human error in that it relies on proper handling of the patron information by the host to ensure that the patron is not served a food item that contains a particular allergen. In addition, like Yahata, et al., the systems and processes of Mimassi only work when the mobile device user enters the restaurant and the geolocating beacon emitted by the host's POS device is detected by the mobile device. Information associated with the beacon is used by a patron management server to retrieve the patron's information and provide it to the host POS device to make the host aware of the allergy information of the patron. Also, the systems and processes of Mimassi only work for the particular user of the mobile device because the information used by the patron management server to retrieve the patron's information is information associated with geolocating the particular mobile device.

A need exists for a system and method that allow users to place food orders via a mobile device in a way that eliminates or at least greatly reduces the possibility of allergens being present in the food order due to human error occurring on the part of the mobile device user, the employee operating the POS terminal at the restaurant and/or the employee preparing the food order in the restaurant kitchen.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever Applicable and practical, like reference numerals refer to like elements.

FIG. 1 is a front view of a PCD, which in this example is a smartphone, in which the App of the present disclosure has been installed and is being executed by one or more processors of the PCD to allow an account to be set up for a single individual or for a group of individuals.

FIG. 2 shows a screen that is displayed when the user taps the “Individual” account button of the screen shown in FIG. 1 and then sets up the user's account by entering an email address, a password and then tapping the “Sign Up” button.

FIG. 3 shows a screen that is displayed when the user taps the “Sign Up” button shown in FIG. 2 to allow the user to enter additional information, such as the user's name, date of birth, a name of an emergency contact individual, and the phone number of the emergency contact individual.

FIG. 4 shows the screen that is displayed when the user taps the “Continue” button shown in FIG. 3, which lists many common allergies and also incudes a field to allow the user to enter any other allergies that are not contained in the list.

FIG. 5 shows a screen that is displayed when the user taps the “Medications” button shown in FIG. 4 to allow the user to enter a list of the allergy medications that the user takes as well as any medications to which the user is allergic.

FIG. 6 shows a screen that is displayed to the user when the user taps the “Setup Account” button shown in FIG. 5 that includes a field for the user to enter text to search for restaurants in the geographical region.

FIGS. 7-9 show the same screens that are shown in FIGS. 2-4 to allow the user to create profiles for any other members for whom the user wants to add to a group account, such as family members of the user.

FIG. 10 allows the medications for which the member has prescriptions as well as medications to which the member is allergic to be entered, which are then displayed in the screen and become part of the member's allergy profile.

FIGS. 11-14 show screens for allowing the user to enter additional member information and the respective member profiles.

FIG. 15 shows an example of a screen containing a plurality of restaurants that is presented when the user performs a search for restaurants in the area that participate in the Aversion Alert program of the present disclosure.

FIG. 16 shows a screen that displays food items offered by a restaurant called Taka Kitchen when the user makes this selection on the screen shown in FIG. 15.

FIG. 17 shows a screen shown that is displayed upon the ordering party selecting the “No thanks, we will be dining in” button in the screen shown in FIG. 16.

FIGS. 18-21 show examples of screens that are displayed on the display monitor of the POS terminal; FIG. 18 shows an example of a screen saver displayed by the Aversion Alert algorithm; the screen shown in FIG. 19 displays a passcode entry field to all an authorized user of the POS terminal to operate the terminal; when the user enters the user's passcode, the screen shown in FIG. 20 is displayed.

FIG. 21 shows an example of an order ticket that is displayed on a display device in a kitchen alerting the food preparer to which orders cannot contain particular allergens.

FIG. 22 shows a screen that is displayed on the PCD to allow the user to make an emergency call for help in the event that a user or member of his group is suffering an allergic reaction.

FIG. 23 shows a QR code that may be present at tables of restaurants that use the Aversion Alert system; scanning the QR code is causes the restaurant menu to be displayed on the phone, along with a pop-up message that informs the customer that if they suffer any food allergens to specify them so that the menu will be filtered based on their allergens.

FIG. 24 shows an example of a screen that is displayed on the customer's PCD after they scan the QR code to allow the customer to proceed with specifying if he/she has any food allergens so that the Aversion Alert algorithm performed by the POS terminal can ensure that only items from the menu that do not have those allergens specified by the customer are shown in a limited menu to the customer.

FIG. 25 shows a screen of menu items that are free of the allergens listed by the customer on the previous screen of FIG. 24 being displayed to the customer.

FIG. 26 shows a functional block diagram of the system of the PCD for performing the Aversion Alert App algorithm(s) in accordance with a representative embodiment; the Aversion Alert system that runs on the POS terminal can have a configuration similar to or identical to the system shown in FIG. 26.

FIG. 27 illustrates a flow diagram of the Aversion Alert process performed by PCDs of users.

FIG. 28 illustrates a flow diagram of the Aversion Alert process performed by the POS terminals.

### DETAILED DESCRIPTION

The present disclosure is directed to various representative embodiments of a system and method that allow users to place food orders via a mobile device in a way that eliminates or at least greatly reduces the possibility of allergens being present in the food order due to human error occurring on the part of the mobile device user, the employee operating the POS terminal at the restaurant and/or the employee preparing the food order in the kitchen of the restaurant.

In accordance with a representative embodiment, one method of the present disclosure is performed by the mobile device and another method of the present disclosure is performed by the POS terminal located at the restaurant or other establishment offering food items for sale. Similarly, one system of the present disclosure is implemented in the mobile device and another system of the present disclosure is implemented by the POS terminal. Preferably, an Aversion Alert App executed by a processor of the mobile device performs the method steps and system functions. Preferably, an Aversion Alert software and/or firmware computer program executed by a processor of the POS system causes the processor to perform the method steps and system functions. It should be noted, however, that the methods and systems disclosed herein can be implemented in a number of ways in computer hardware, software, firmware, or any combination thereof. For case of discussion, the following description of the inventive principles and concepts will be described with reference to an App that is executed by a smartphone and a software computer program executed by a POS terminal.

In accordance with a preferred embodiment, during a food ordering session that takes place after completion of an account setup process with the Aversion Alert App running on a personal computing device (PCD), such as a smart phone, for example, the PCD searches in the vicinity of the PCD for restaurants or other food ordering establishments that use a POS terminal configured to execute an Aversion Alert computer program to interact with any PCD performing the Aversion Alert App. Restaurants found in the search are displayed on a display device of the PCD. Upon the PCD user selecting one of the displayed restaurants, only menu items of the selected restaurant that do not include the allergens listed in the profile information associated with the user are displayed on the display device of the PCD. Upon the user selecting one of the displayed menu items, an order for the selected menu item is placed with the POS terminal of the selected restaurant.

Aspects, features and advantages of several exemplary embodiments of systems and methods of the present disclosure will become better understood with regard to the following description in connection with the accompanying drawings. It will be apparent to one of ordinary skill in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, any use of absolute terms such as, for example, “will,” “will not.” “shall.” “shall not.” “must” and “must not” are not meant to limit the scope of the disclosure as the particular embodiments disclosed herein are merely exemplary.

The word “exemplary” is used herein to mean serving as an example, instance, or illustration. Any aspect described herein as “exemplary” is not necessarily to be construed as exclusive, preferred or advantageous over other aspects.

In this description, the term “Application” or “App” may also include files having executable content, such as: object code, scripts, byte code, markup language files, and patches. In addition, an “App” referred to herein, may also include files that are not executable in nature, such as documents that may need to be opened or other data files that need to be accessed.

In this description, the terms “subject,” “operator” and “user” are used interchangeably unless otherwise noted.

As used in this description, the terms “component,” “database.” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an App running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”).” “graphical processing unit (“GPU”),” “processing component” and “chip” are used interchangeably. Moreover, a CPU, DSP, GPU or chip may be comprised of one or more distinct processing components generally referred to as “core(s).”

In this description, the term “portable computing device” (“PCD”) is used to describe any device operating on a limited capacity power supply, such as a battery. Therefore, a PCD may be, for example, a cellular telephone, a satellite telephone, a pager, a PDA, a smartphone, a navigation device, a smartbook or reader, a media player, a combination of the aforementioned devices, a laptop computer with a wireless connection, a remote sensor package worn by a user, among others.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and Appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or more memory devices. The memory may, for example, be multiple memories within the same computer system. The memory may also be multiple memories distributed amongst multiple computer systems or computing devices.

A “processor”, as that term is used herein encompasses an electronic component that is able to execute a computer program or executable computer instructions. References herein to a computer comprising “a processor” should be interpreted as one or more processors or processing cores. The processor may for instance be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

The term “restaurant”, as that term is used herein, is intended to denote any establishment that serves food of any type and/or beverages of any type and that includes a POS terminal, including establishments that are traditionally viewed as restaurants such as fast-food restaurants, fine-dining restaurants, bistros, etc., as well as establishments that serve some type of food and/or beverages, but that are not normally considered to be “restaurants” in the traditional sense, such as coffee shops, bakeries, delicatessens, food kiosks, etc. A “food order” or “food item”, as those terms are used herein, are used interchangeably herein and are intended to denote any type of edible or drinkable product intended for consumption.

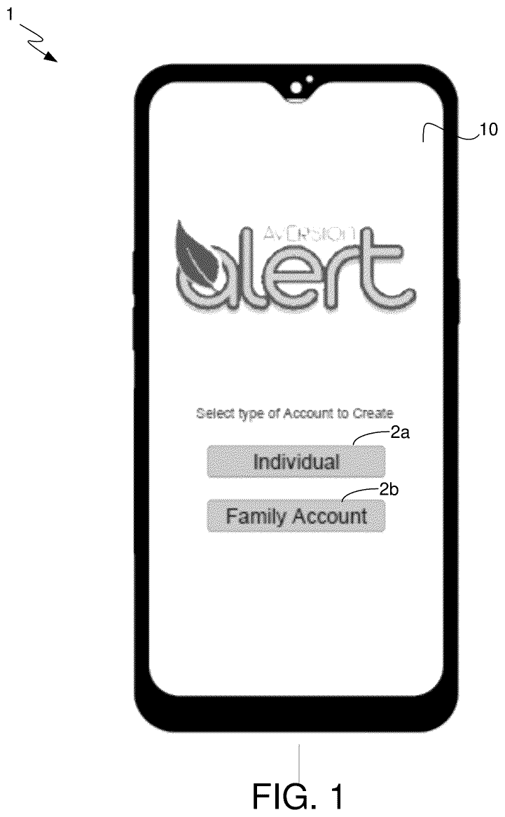

FIG. 1 is front view of a PCD 1, which in this example is a smartphone, in which the App of the present disclosure has been installed and is being executed by one or more processors of the PCD. In accordance with a preferred embodiment, the App is configured to allow an account to be set up for a single individual or for a group of individuals, such as the family members of the PCD user. This ensures that allergen-free food orders can be ordered via the PCD for a single PCD user or for multiple individuals, which is not possible with the prior art systems and methods discussed above. In accordance with a preferred embodiment, once the PCD user has finished setting up the accounts, the PCD user can switch between the user's account and any other group members for which accounts have been created during a food ordering session. This allows the user to place allergen-free orders for the user and any other group members.

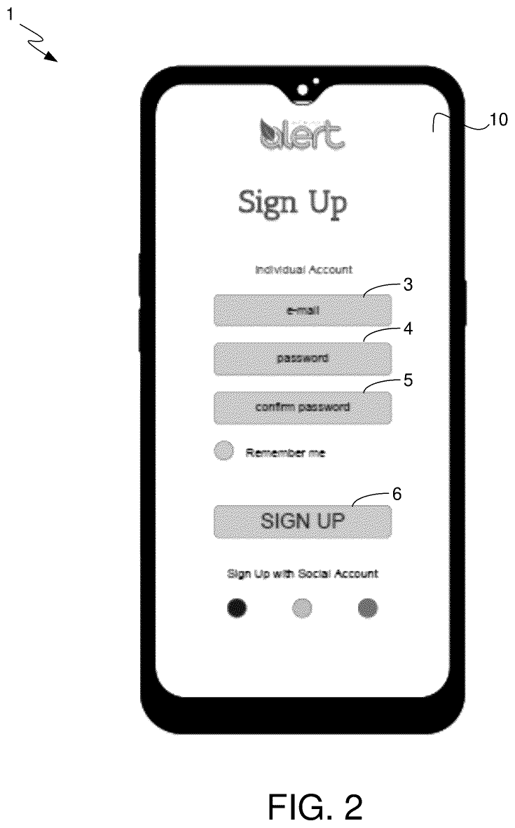

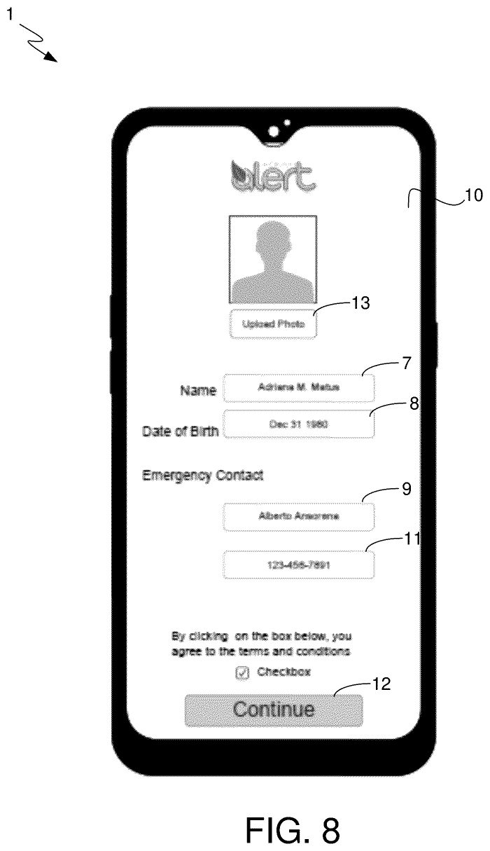

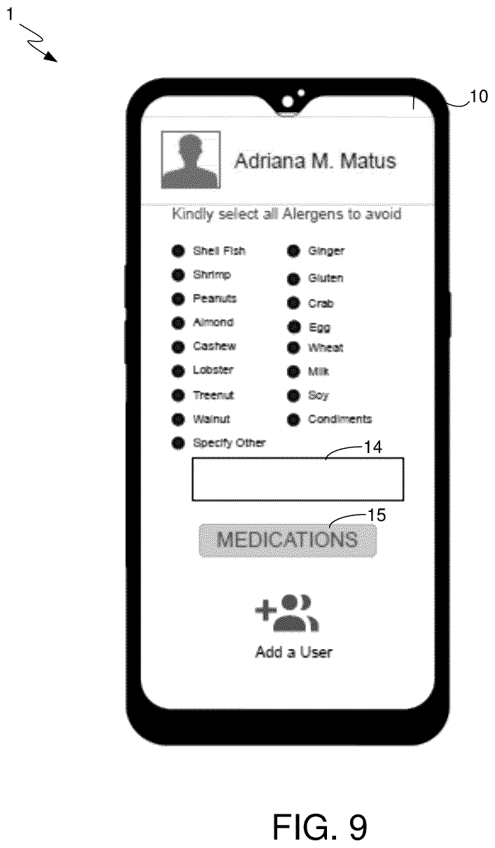

FIGS. 1-14 depict different interactive screens that are displayed to the user on the PCD display device 10 during the account setup process during which the PCD user sets up an account and an allergy profile for the PCD user and/or for one or more other individuals, such as the spouse and children of the PCD user. The display device 10 shown in FIG. 1 displays an “Individual” account button 2a and a “Family Account” button 2b to allow the user to set up an account for the user and for the family of the user, respectively. The screen shown in FIG. 2 is displayed when the user taps the “Individual” account button of the screen shown in FIG. 1. In the screen shown in FIG. 2, the user sets up the user's account by entering an email address by clicking on button 3 and entering the user's email address, a password by clicking on the password button and entering a password, clicking on confirm button 5 to confirm the password, and then tapping the “Sign Up” button 6. Below the “Sign Up” button are options that allow the PCD user to automatically register the account by selecting one of a plurality of social media accounts that the user already has.

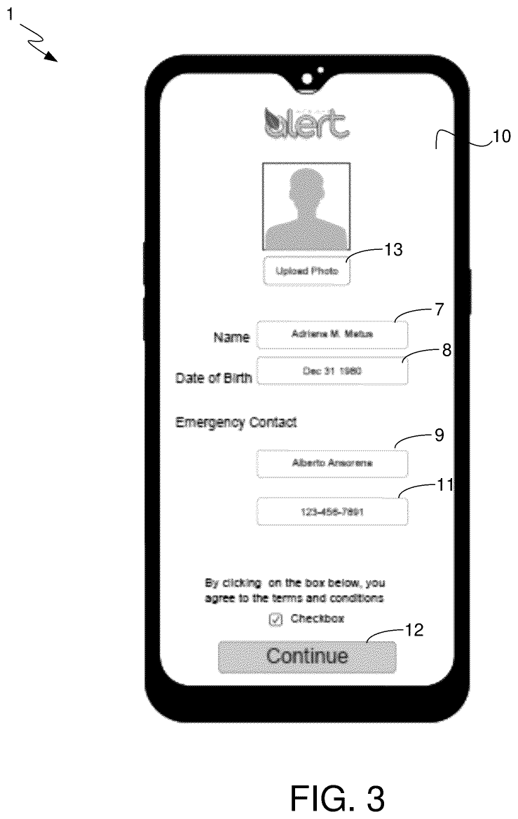

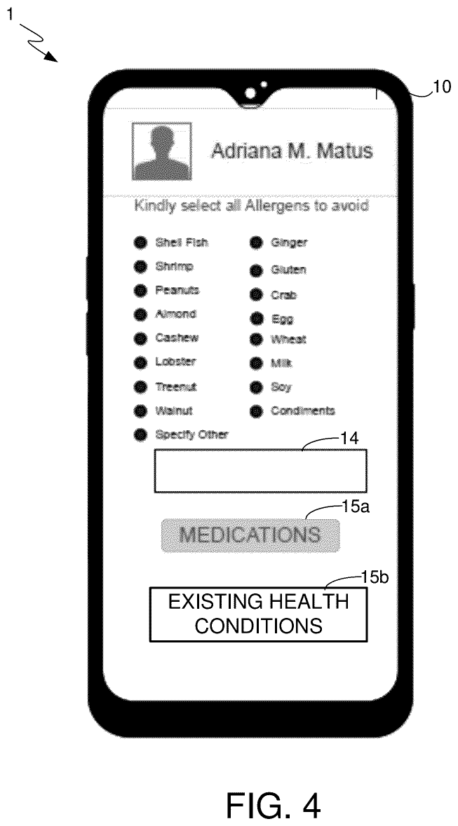

The screen shown in FIG. 3 is displayed when the user taps the “Sign Up” button shown in FIG. 2 to allow the user to enter additional information, such as the user's name in field 7, date of birth in field 8, a name of an emergency contact individual in field 9, and the phone number of the emergency contact individual in field 11. The user can also upload a photograph of the user by clicking on upload button 13 and then attaching a photo. FIG. 4 shows the screen that is displayed when the user taps the “Continue” button 12 shown in FIG. 3. This screen lists many common food items that many people are allergic to that the user can select to add to the user's profile as food items to which the user is allergic. This screen also incudes field 14 to allow the user to enter any other food items that the user may be allergic to that are not contained in the list. This screen allows the user to set up an allergy profile for the user and for any other group members for which the user has already created accounts.

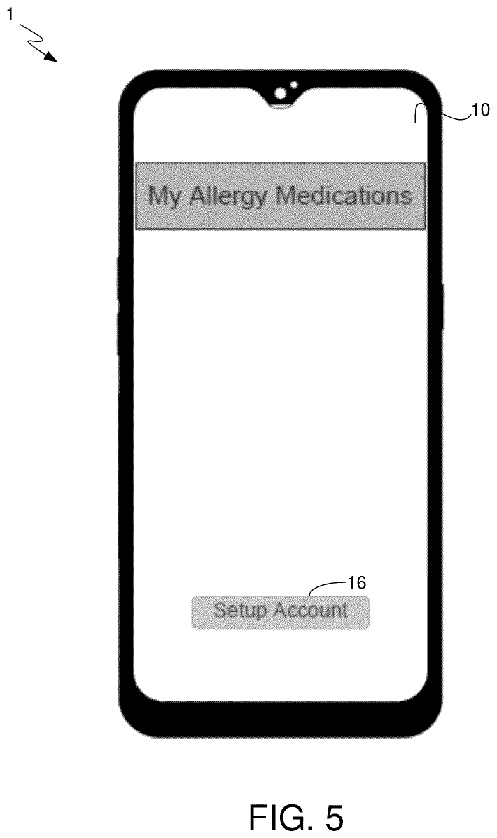

This screen also includes a “Medications” button 15a and an “Existing Health Conditions” button 15b to allow the user to include a list of medications and a list of health conditions, respectively, that should be included in the user or member profile. Under the “Medications” button, the user can also enter in a separate category medications to which the user is allergic. FIG. 5 shows a screen that is displayed when the user taps the “Medications” button 15a shown in FIG. 4. The screen shown in FIG. 5 lists the medications that the user has entered. A similar screen can be displayed that lists the user's existing medical conditions.

At this point, all of the information that is needed to create an account has been entered. After entering the list of medications, the user simply taps the “Setup Account” button 16 shown in FIG. 5 to complete the process. When the user taps this button, the allergy profile information associated with the user and with each group member for whom an account has been created is stored in a memory device of the PCD. This information may also be stored at some other suitable location, such as in a server of a network cloud. Subsequently, when the user uses the PCD to place a food order, a processor of the PCD will perform a process of the present disclosure that ensures that only allergy-free food orders are placed, as will be described below in more detail. Tapping the “Setup Account” button 16 can also cause a prompt to be displayed instructing the PCD user to check his or her email account for an email message having an activation link that the user can click to complete the setup process.

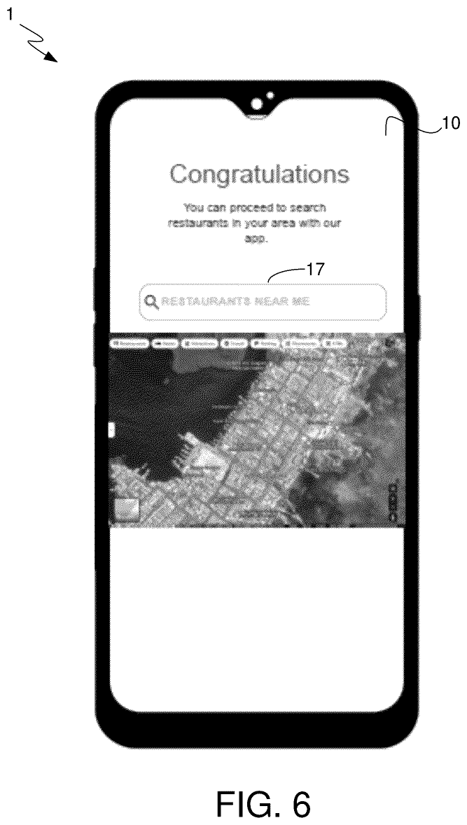

FIG. 6 shows a screen that is displayed to the user when the user taps the “Setup Account” button 16 shown in FIG. 5. The screen includes a field 17 for the user to enter text to search for restaurants in the user's geographical region. As with most smartphones, the PCD typically also allows the user to search using an audio command. When the user searches for restaurants, preferably only restaurants having a POS terminal that has been configured to perform the Aversion Alert process in accordance with the inventive principles and concepts disclosed herein will be displayed to the user. The algorithms that are performed by the PCD and by the POS terminal are referred to hereinafter as the “Aversion Alert” algorithms. Both the PCD and the POS terminal are configured to execute some version of the Aversion Alert algorithm to allow them to communicate with one another to ensure that only allergen-free food orders are placed and prepared.

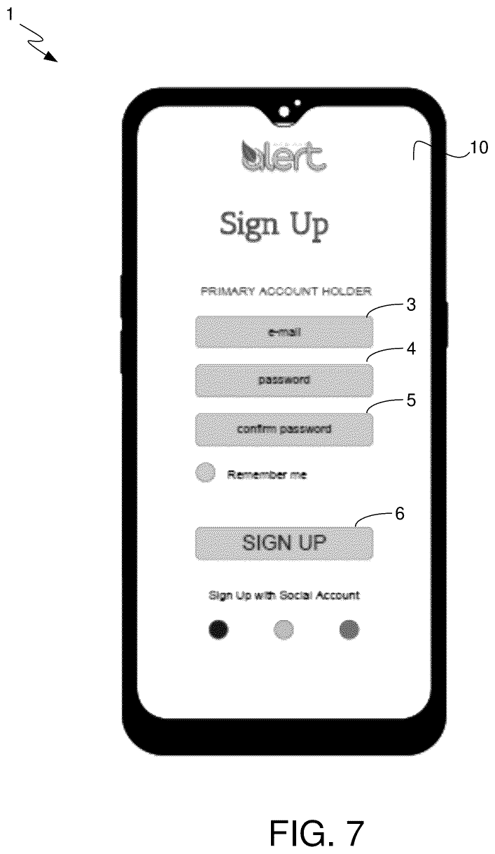

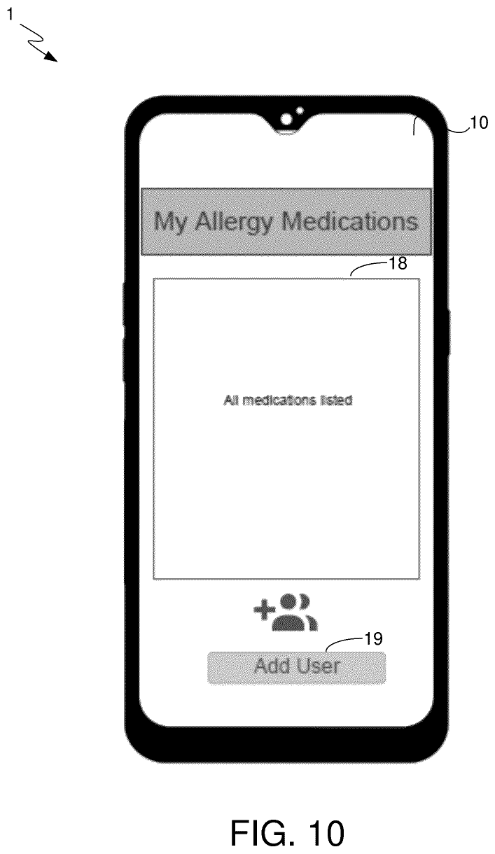

FIGS. 7-9 show the same screens that are shown in FIGS. 2-4. FIGS. 7-9 allow the user to create profiles for any other members for whom the user wants to add to a group account. Thus, each member of the group has an allergy profile that is specific to that person. FIG. 10 shows a screen displayed that allows the medications for each member to be entered into a field 18, which are then displayed in the screen and become part of the member's allergy profile. The screen shown in FIG. 10 also displays an “Add User” button 19 to allow the user to continue adding group members and their respective profiles.

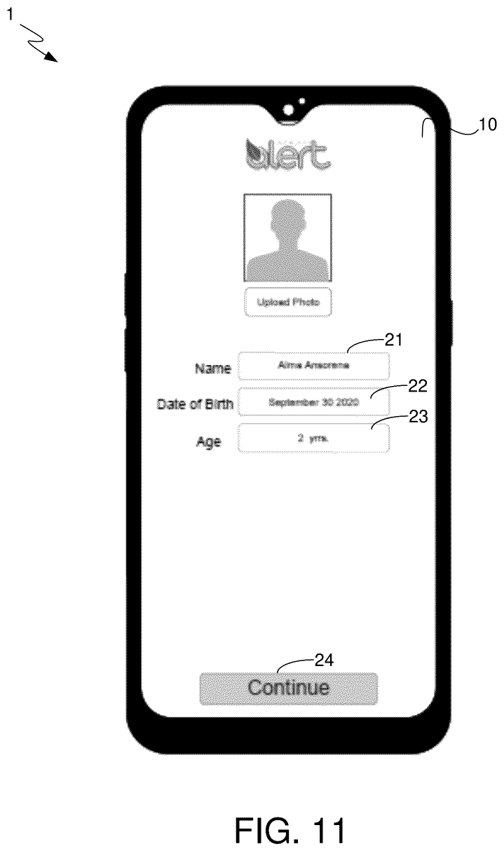

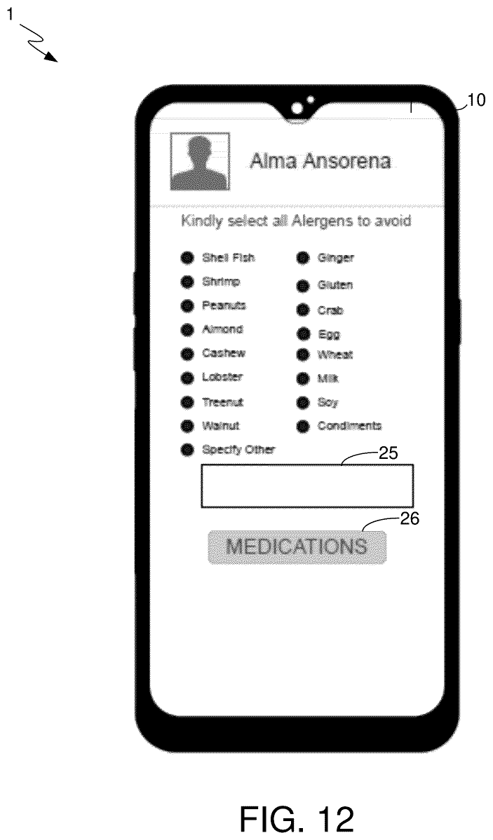

FIGS. 11-14 show screens for allowing the user to enter additional member information and the respective profiles. Fields 21-23 of FIG. 11 allow the user to enter the name, date of birth and age, respectively, of an additional member. The user then selects the continue button 24 to cause the member information to be stored in memory of the PCD 1. The screen shown in FIG. 12 lists many common food items that many people are allergic to that the user can select to add to the member's profile. This screen also incudes field 25 to allow the user to enter any other food items that the member may be allergic to that are not contained in the list. This screen also includes a “Medications” button 26 to allow the user to include a list of medications that should be included in the member's profile.

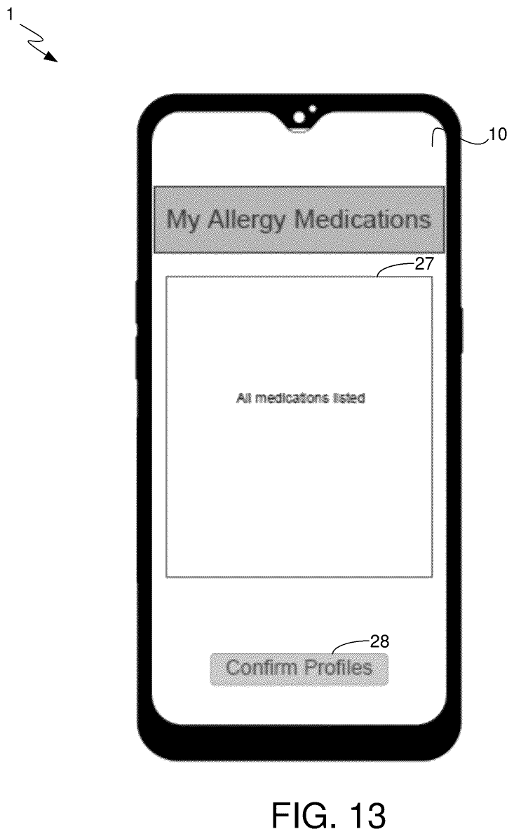

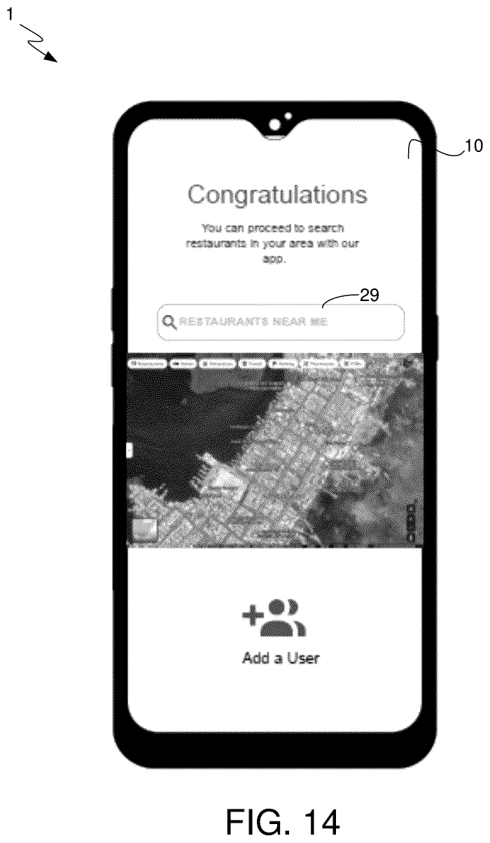

FIG. 13 shows a screen that is displayed when the user taps the “Medications” button 15 shown in FIG. 12. The screen shown in FIG. 13 has a field 27 in which the user lists the member's allergy medications. After entering the list of medications, the user taps the “Confirm Profiles” button 28 shown in FIG. 13 to complete the process. When the user taps this button, the allergy profile information associated with the group member for whom an account has been created is stored in a memory device of the PCD and the screen shown in FIG. 14 is displayed. This information may also be stored at some other suitable location, such as in a server of a network cloud.

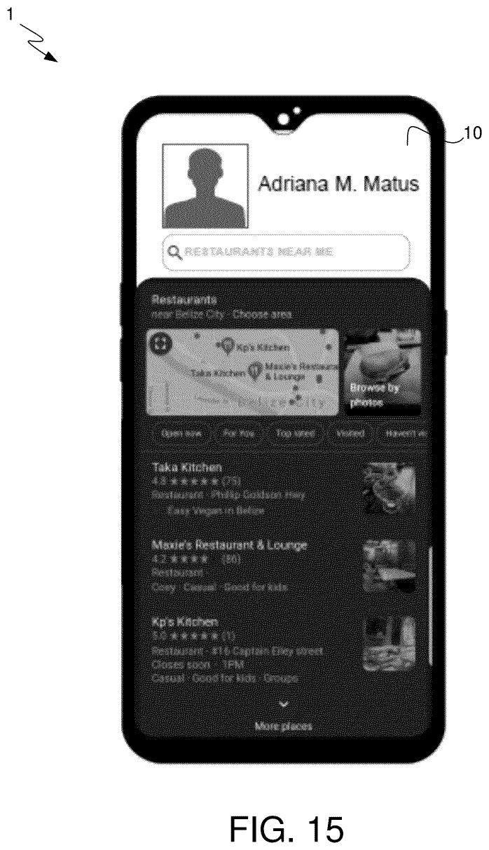

Subsequently, when the user uses the PCD to place a food order by entering a search query into field 29 shown in FIG. 14, a processor of the PCD will perform the process of the present disclosure discussed above that ensures that only allergy-free food orders are placed, as will be described below in more detail. FIG. 15 shows an example of a screen containing a plurality of restaurants that is presented when the user performs a search for restaurants in the area that participate in the Aversion Alert program. The PCD's location setting is turned on so that restaurants within a particular geographical area are options to be displayed. In this example, the search is being performed for a member of the user's family, Adriana. In this example, three different restaurants and associated information are displayed in the screen based on Adriana's allergen profile.

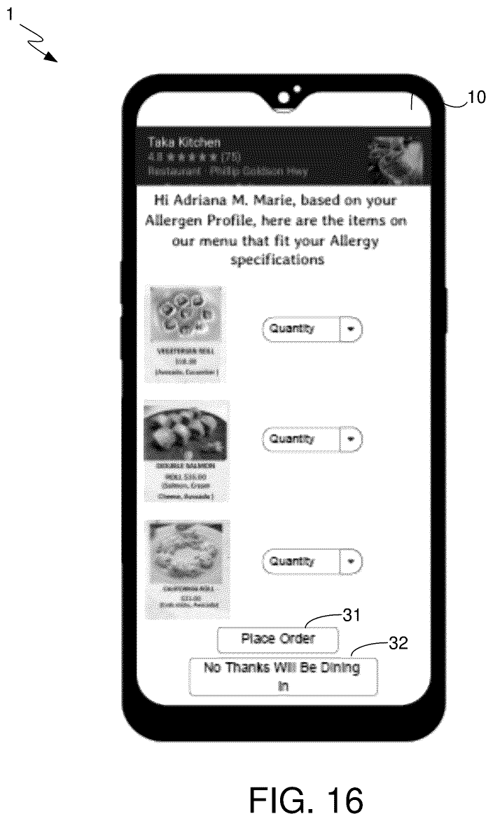

FIG. 16 shows a screen that displays food items offered by Taka Kitchen when the user makes this selection on the screen shown in FIG. 15. It can be seen in FIG. 16 that the only food items that are displayed are those which do not include the food allergens listed in Adriana's allergy profile. The Aversion Alert algorithms performed by the PCD processor and by the processor of the POS terminal work together to ensure that only those food items from the menu are displayed. As will be described below in more detail, participating restaurants have profiles for each menu item stored in a memory device of the POS terminal. During a food ordering session, the algorithms cooperate to ensure that the allergy profile of the person for whom the order is being placed is compatible with the profile of the food items that are displayed on the screen shown in FIG. 16. Either the Aversion Alert algorithm running on the PCD or the Aversion Alert algorithm running on the POS terminal compares the profiles to ensure that the displayed menu items do not contain any allergens contained in the user's or member's profile. Alternatively, the Aversion Alert algorithm being performed by the PCD and the Aversion Alert algorithm being performed by the POS terminal can perform this comparison process in parallel, assuming the food order profiles are passed to the PCD. In accordance with a representative embodiment, the allergy profile of the person for whom the order is being placed is passed to the POS terminal, which then performs the comparison process and displays only those food items that are safe for the party placing the order.

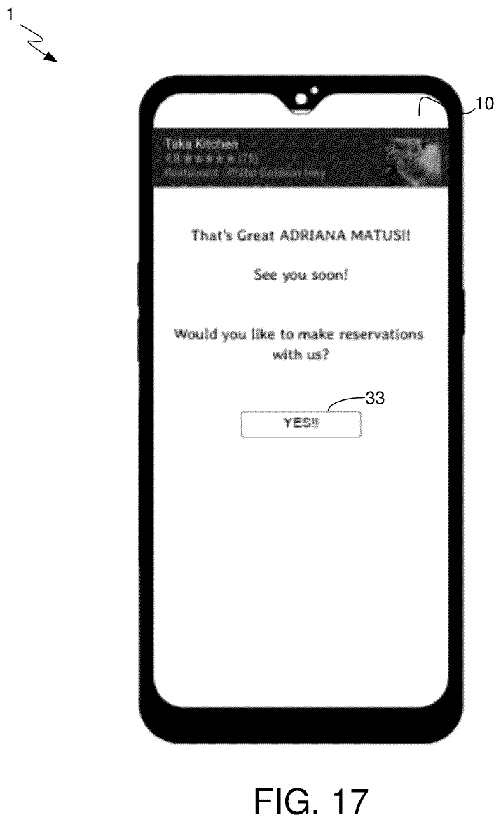

In accordance with a representative embodiment, the ordering party selects a food item shown in the screen of FIG. 16 and the quantity and taps either the “Place Order” button 31 or the “No thanks, we will be dining in” button 32 to indicate that they will be taking out or dining in, respectively. Another option that is not shown for ease of illustration could be delivery of the food order. The screen shown in FIG. 17 is displayed upon the ordering party selecting the “No thanks, we will be dining in” button in the screen shown in FIG. 16. When the user selects the “Yes” button 33 in the screen shown in FIG. 17, the Aversion Alert App being executed by the PCD preferably shows available seating in real-time to allow the ordering party to select seating, enter a date, time, number of persons who will be dining, etc., which the Aversion Alert algorithm being performed by the POS terminal will then update on the restaurant's reservation list. Alternatively, the Aversion Alert algorithm being executed by the POS terminal can perform these operations by querying the ordering party as to the time and date of the reservation they are requesting, the number of people who will be dining in, etc., and then automatically updates its reservation list accordingly.

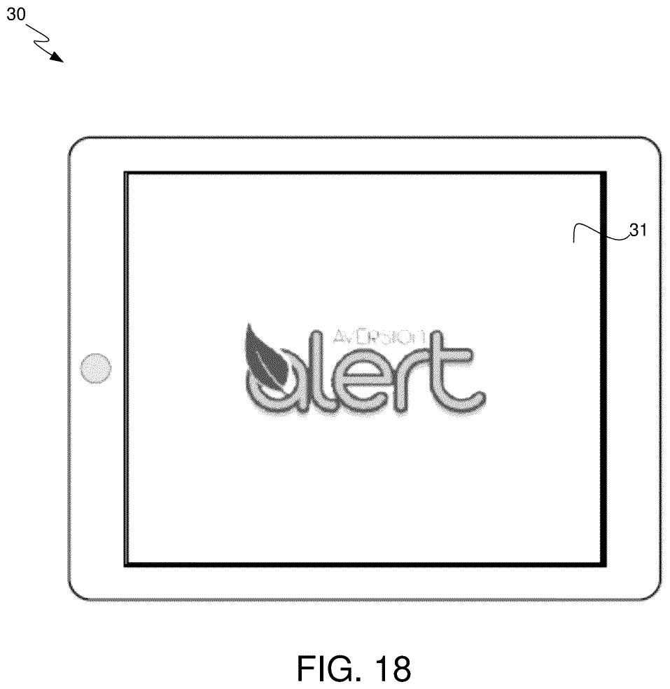

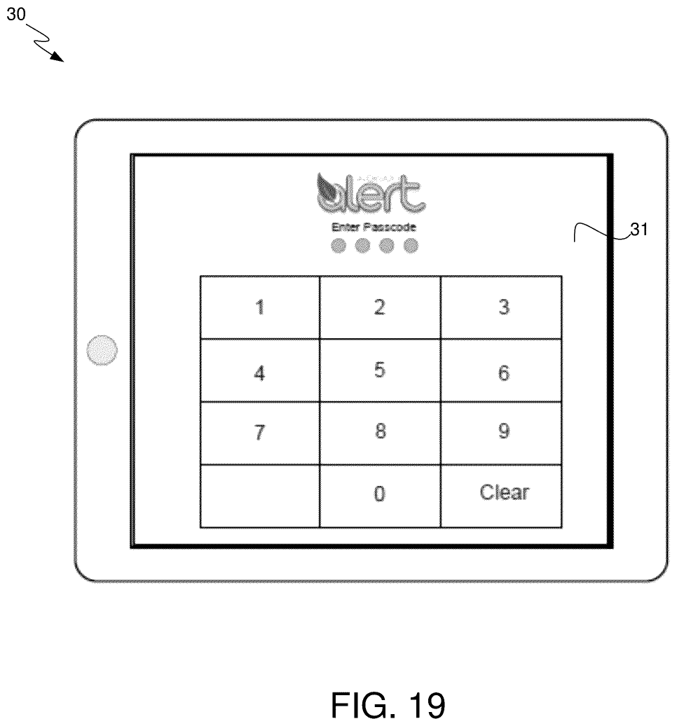

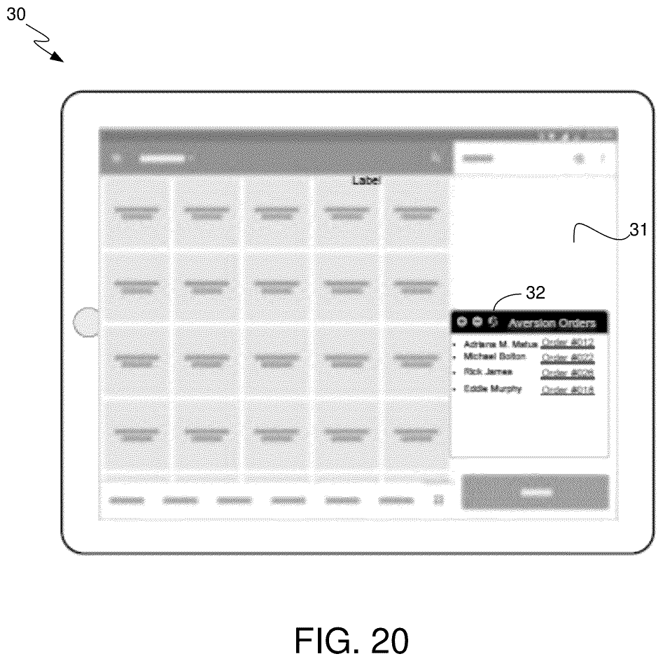

FIGS. 18-21 show examples of screens that are displayed on the display monitor 31 of the POS terminal 30, which in this example is a tablet PCD or iPad PCD. FIG. 18 shows a screen saver displayed by the Aversion Alert algorithm. The screen shown in FIG. 19 displays a passcode entry field to allow an authorized user of the POS terminal 30 to operate the terminal 30. When the user enters the user's passcode, the screen shown in FIG. 20 is displayed. On this screen, the orders placed by the PCDs of ordering parties who suffer allergies will appear in a separate box 32 with their user names and corresponding order numbers made visible. For others who do not suffer any food allergies, their orders preferably would appear in a separate box. This feature help ensure that no human error occurs by the person operating the POS terminal 30 that could lead to allergens being contained in food orders. Preferably, this screen or some version of it is also transmitted to a display device in the kitchen to alert the food preparer of which orders must be devoid of particular allergens. This feature further reduces the possibility of allergens being present in a food order due to human error in the kitchen.

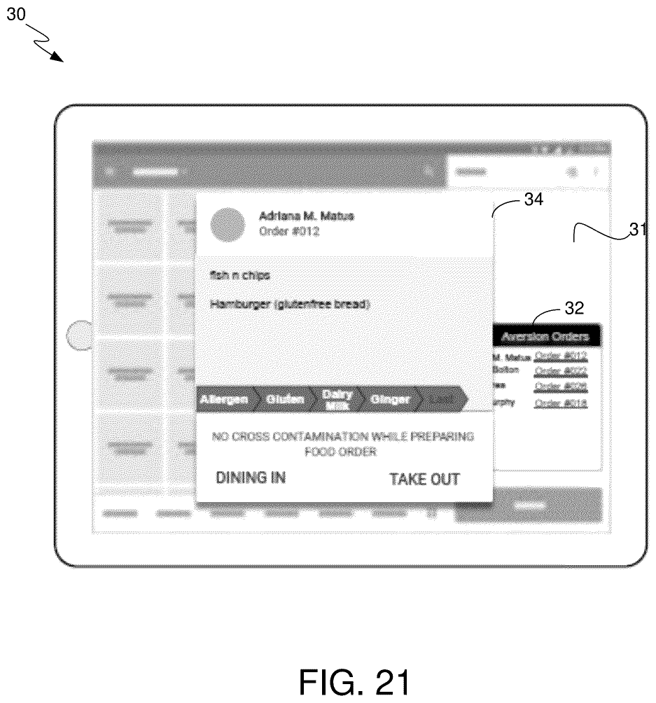

FIG. 21 shows an example of the ticket 34 that is displayed on the display device 31 of the POS terminal 30 alerting the food preparer of which orders cannot contain particular allergens. Preferably the ticket 34 is displayed when the user of the POS 30 selects the order number beside the customer's name in the box 32. This is just a further step in avoiding human error because this will also help the POS operator and the food preparer take steps to avoid cross contamination. Whether it is an individual order or group order, a list of all allergens preferably will appear on each ticket 34. This will reinforce that those in the kitchen and the POS operator can visibly see the allergens.

Individuals who suffer no allergens would also be able to order with the Aversion Alert App, with the only difference being that the ticket order displayed in the kitchen and on the POS terminal 30 would only have the user's name and order, i.e., no reference to cross contamination and allergens would be listed on the ticket order. Preferably, for food orders that are shown for a group account, some distinguishing feature such as color and/or font, for example, will be used to distinguish the food orders that are associated with persons who are allergic to one or more allergens and food orders that are associated with someone who has no allergies.

In accordance with an embodiment, when the POS terminal closes out an order for a customer who ordered with the Aversion Alert App on the PCD, the Aversion Alert algorithm performed by the POS terminal will automatically send a request to the PCD user to rate and review the establishment. This feature will help with bringing more clientele to the establishment as with building more consumer confidence in the Aversion Alert system of the present disclosure.

It should be noted that the POS terminal 30 may be a PCD and the Alert Aversion program that runs on the terminal 30 can be an App that is downloaded from a website or App store. Regardless of the type of computer program that the the POS terminal 30 runs, it preferably will be configurable by a restaurant employee or contractor to all them to upload the restaurant menu and the list of allergens associated with the menu items to the POS terminal 30.

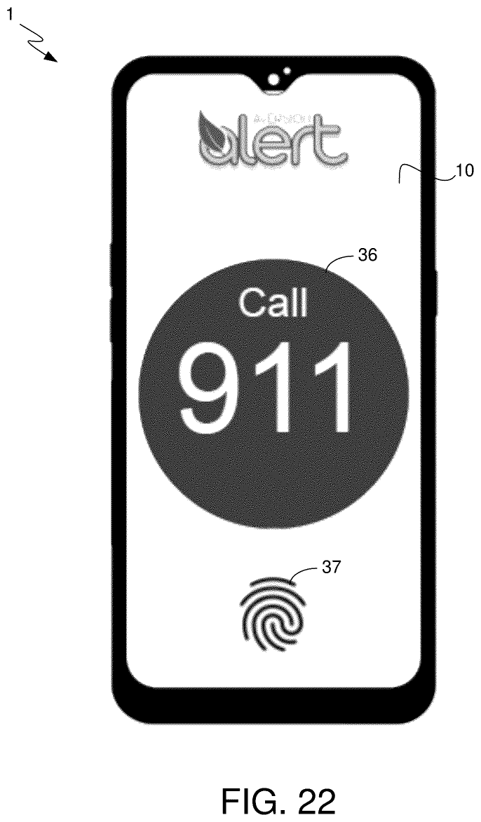

FIG. 22 displays a screen that the Aversion Alert App of the PCD can display on the display device 10 of the PCD 1 to allow the user to make an emergency call for help in the event that a user or member of his group is suffering an allergic reaction. For example, in the event that the user is alone and begins to suffer an allergy attack whereby she/he is unable to speak due to their throat enclosing, they can select the emergency button 36 on the screen, “Call 911”. In accordance with an embodiment, the emergency call can only be activated by the user's fingerprint being scanned at location 37 on the display device 10. This is a safety feature so as to prevent children from accidentally enabling the call. The app would then proceed to call both 911 and the emergency contact contained in the user or group member's profile. The App preferably would then automatically provide the emergency operator with: (1) latitude/longitude coordinates and/or business establishment address; (2) allergy medications that the person uses; and (3) a list of existing health conditions. That is the purpose of having the “Medication” section when creating the account and setting up the profiles.

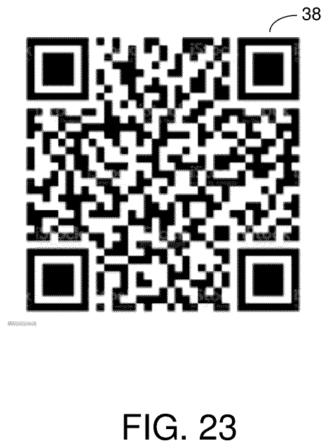

FIG. 23 shows a QR code 38 that may be present at the tables of restaurants that use the Aversion Alert system. There will likely be persons that have food allergens, but who are not familiar with the Aversion Alert App. For restaurants that use the Aversion Alert system of the present disclosure, when the QR code 38 is scanned to allow customers to view the menu on their phones, the Aversion Alert algorithm running on the restaurants system could be configured to cause a pop-up message to be displayed on the customer's phone that informs the customer that if they suffer any food allergens to specify them so that the menu will be filtered based on their allergens. The message could also prompt the user to download and install the Aversion Alert App on the user's PCD and then place an order. Those who do not suffer allergies can just close the message and order from the menu as is typically done.

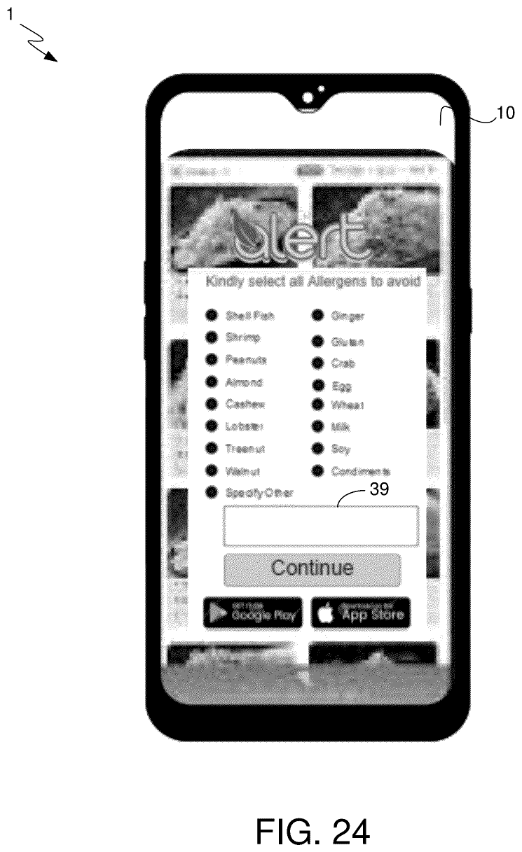

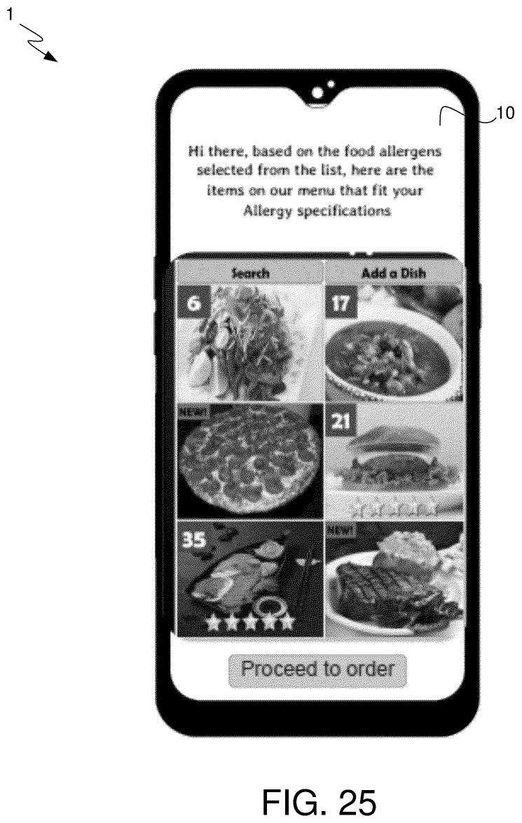

FIG. 24 shows an example of a screen that is displayed on the customer's PCD after they scan the QR code 38. After scanning the QR code 38 to cause the menu to be displayed on the customer's PCD, a field 39 appears on the customer's PCD to allow the customer to proceed with specifying if he/she has any food allergens. It should be noted that the App communicates with the POS terminal 30, so that based on keywords entered in the field 39, the Aversion Alert algorithm performed by the POS terminal 30 can cause only items from the menu that do not have those allergens to be shown in a limited menu to the customer. FIG. 25 shows a screen of menu items that are free of the allergens listed by the customer on the previous screen being displayed to the customer. Once the order is placed, the other features discussed above would then take place in the same way as if a user having the Aversion Alert App installed on the user's PCD placed the order, i.e., the ticket 34 displayed in the kitchen would be similar to the what is shown in FIG. 21.

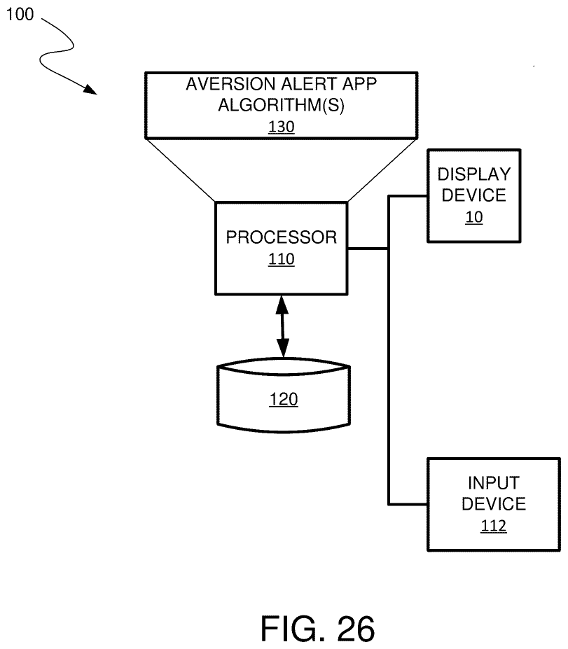

FIG. 26 shows a functional block diagram of the system 100 of the PCD for performing the Aversion Alert App algorithm(s) 130. A processor 110 of the system performs the operations described above, e.g., setting up user and group member profiles, which the processor 110 stores in memory device 120 for later use, allowing a user to search for restaurants in the vicinity that have the Aversion Alert system of the present disclosure on the premises, view menu items that are allergen free, order menu items that are allergen free, etc. The display device 10 of the system 100 displays the screens discussed above with reference to the figures that are displayed on the PCD. An input device 112 of the system 100 can include a text input device, an audio input device, and/or other input devices for allowing the user to set up a profile, perform searches, place orders, etc.

The memory device 120 can store the user and group member profiles as well as computer instructions comprising the Aversion Alert App algorithm(s), which are executed by the processor 110 when it runs the Aversion Alert App. The App can be ordered in, for example, an App store (e.g., the Apple store) of the PCD or from any other suitable location, and installed on the PCD. The memory device 120 is a non-transitory computer readable medium.

The Aversion Alert system (not shown) that runs on the POS terminal can have a configuration similar to or identical to the system 100 shown in FIG. 26. Therefore, in the interest of brevity, the Aversion Alert system of the POS terminal will not be described herein in further detail.

Some portions of this specification are presented in terms of algorithms performing operations on data stored as bits or binary digital signals within a machine memory (e.g., a computer memory). As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content.” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing.” “computing,” “calculating.” “determining.” “presenting.” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

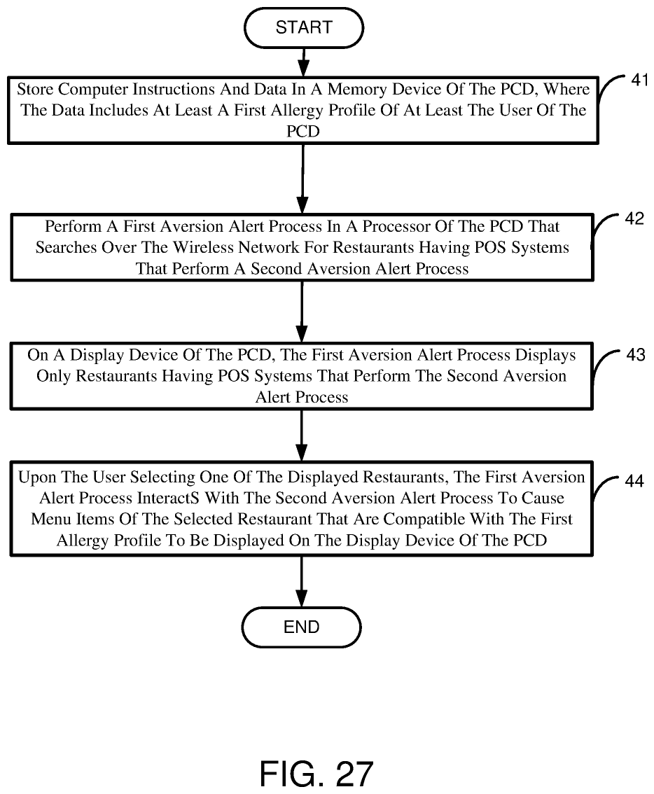

FIG. 27 illustrates a flow diagram of the Aversion Alert process performed by PCDs of users. Block 41 represents the step of storing computer instructions and data in a memory device of the PCD, where the data includes at least a first allergy profile of at least the user of the PCD. Block 42 represents the step performing a first Aversion Alert process in a processor of the PCD that searches over the wireless network for restaurants having POS systems that perform a second Aversion Alert process. The processor displays only restaurants that have POS terminals that perform the second Aversion Alert process, as indicated by block 43. Upon the user selecting one of the displayed restaurants, the first Aversion Alert process interacts with the second Aversion Alert process to cause menu items of the selected restaurant that are compatible with the first allergy profile to be displayed on a display device of the PCD, as indicated by block 44.

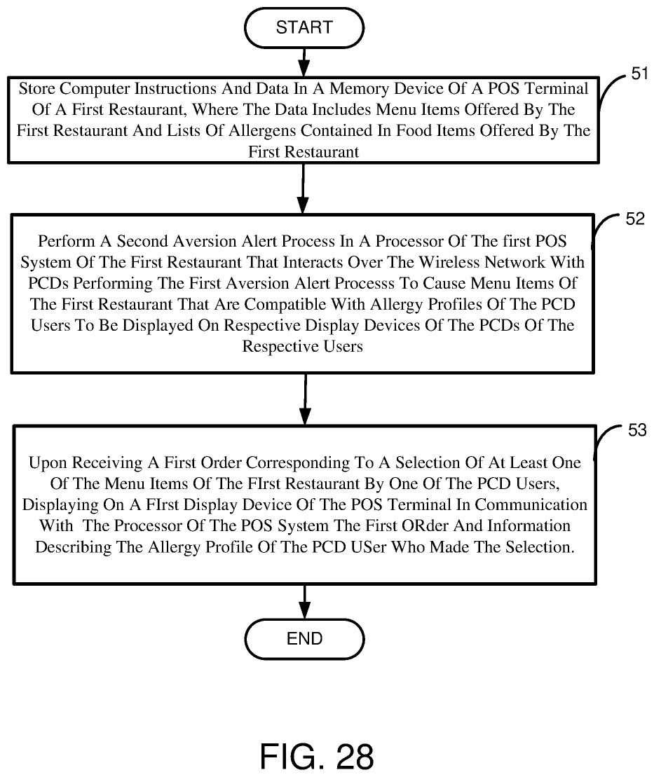

FIG. 28 illustrates a flow diagram of the Aversion Alert process performed by the POS terminals. Block 51 represents the step of storing computer instructions and data in a memory device of a first POS system of a first restaurant, where the data includes menu items offered by the first restaurant and lists of allergens contained in menu items offered by the first restaurant. Block 52 represents the step of performing the second Aversion Alert process in a processor of the first POS system that interacts over the wireless network with PCDs performing the first Aversion Alert process to cause menu items of the first restaurant that are compatible with allergy profiles of the PCD users to be displayed on respective display devices of the PCDs of the respective users. Block 53 represents the step of, upon receiving a first order corresponding to a selection of at least one of the menu items of the first restaurant by one of the PCD users, displaying on a first display device of the POS terminal in communication with the processor of the POS system the first order, the displayed first order including information describing the allergy profile of the PCD user who made the selection. As indicated above, preferably this information is also displayed on a display device located in the kitchen.

It should be noted that the figures depict preferred or representative embodiments of the Aversion Alert system and method for purposes of illustration only. One skilled in the art will readily recognize from the description that alternative embodiments or modifications of the systems and methods illustrated herein may be employed without departing from the principles described herein.

Various modifications, changes and variations can be made to the systems and methods of the present disclosure, as will be apparent to those skilled in the art in view of the present disclosure within the scope of the present disclosure and the appended claims.

The POS system can also be configured to generate a monthly report to all users showing them figures based on searches for foods by users who were in the area searching for foods that they can consume based on allergens. This in itself can serve as a competitive edge for restaurants to tweak their menus to appeal to this clientele.

As indicated above, the POS system and the PCD App communicate with one another. For example, if the PCD running the Aversion Alert App is within a particular distance (e.g., a 1 mile radius) of a restaurant that is using the Aversion Alert POS software, the POS can be configured to send a notification to that user of a “lunch special” the restaurant is having. This would be for all users, i.e., for those who do and, do not have a food allergens. For those who have allergies, preferably only lunch specials that are compatible with the PCD user's or member's profile are displayed on the PCD.

It should be noted that any or all portions of algorithms described above that are implemented in software and/or firmware being executed by a processor (e.g., processor 110) can be stored in a non-transitory memory device, such as the memory 120. For any component discussed herein that is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages. The term “executable” means a program file that is in a form that can ultimately be run by the processor. Examples of executable programs may be, for example, a compiled program that can be translated into machine code in a format that can be loaded into a random access portion of the memory 120 and run by the processor 110, source code that may be expressed in proper format such as object code that is capable of being loaded into a random access portion of the memory and executed by the processor, or source code that may be interpreted by another executable program to generate instructions in a random access portion of the memory to be executed by the processor, etc.

An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, static random access memory (SRAM), dynamic random access memory (DRAM), magnetic random access memory (MRAM), a programmable read-only memory (PROM), an erasable programmable read-only memory (EPROM), an electrically erasable programmable read-only memory (EEPROM), or other like memory device.

It should be noted that the inventive principles and concepts have been described with reference to representative embodiments, but that the inventive principles and concepts are not limited to the representative embodiments described herein. As indicated above, steps not depicted in the flow diagrams can be added and steps that are depicted in the flow diagrams can be modified or eliminated altogether. Although the inventive principles and concepts have been illustrated and described in detail in the drawings and in the foregoing description, such illustration and description are to be considered illustrative or exemplary and not restrictive; the invention is not limited to the disclosed embodiments. Other variations to the disclosed embodiments can be understood and effected by those skilled in the art, from a study of the drawings, the disclosure, and the Appended claims.

1. A system embodied in a personal computing device (PCD) for allowing a user of the PCD to use the PCD to place food orders with restaurants over a wireless network, the system preventing or reducing a possibility that a placed food order will contain one or more allergens to which the user is allergic, the system comprising:
a memory device configured to store computer instructions and data, the data including at least a first allergy profile of at least the user of the PCD; and
a processor configured to perform a first Aversion Alert process that searches over the wireless network for restaurants having point-of-sale (POS) systems that perform a second Aversion Alert process and displays only restaurants in the vicinity of the PCD that are performing the second Aversion Alert process, wherein upon a user selecting one of the displayed restaurants, the first Aversion Alert process and the second Aversion Alert process interact with one another to cause only menu items of the selected restaurant that are compatible with the first allergy profile to be displayed on a display device of the PCD.

2. The system of claim 1, wherein if the user selects at least one of the displayed menu items, a first order is placed with the restaurant associated for the selected menu item.

3. The system of claim 1, wherein the order placed with the restaurant includes information describing the first allergy profile.

4. The system of claim 1, wherein the data includes at least a second allergy profile of at least a first member of a group of members of which the user is a member, and wherein the first Aversion Alert process interacts with the second Aversion Alert process to cause menu items of the restaurants that are compatible with the second allergy profile to be displayed on the display device of the PCD.

5. The system of claim 4, wherein if the user selects at least one of the displayed menu items on behalf of the first member, a second order is placed with the restaurant for the menu item selected on behalf of the first member.

6. The system of claim 5, wherein the second order placed with the restaurant includes information describing the second allergy profile.

7. The system of claim 1, wherein the first allergy profile includes a list of items to which the user is allergic.

8. The system of claim 7, wherein the first allergy profile includes a list of medications for which the user has prescriptions.

9. The system of claim 8, wherein the first allergy profile includes a list of existing health conditions of the user.

10. The system of claim 9, wherein the first allergy profile includes contact information for an emergency contact person.

11. A system comprising a point-of-sale (POS) terminal of a restaurant for allowing users of personal computing devices (PCDs) to use the PCDs to place food orders with the restaurant over a wireless network, the system preventing or reducing a possibility that a placed food order will contain one or more allergens to which the users are allergic, the system comprising:
a memory device configured to store computer instructions and data, the data including menu items and lists of allergens contained in the food items; and
a processor configured to perform a first Aversion Alert process that is configured to interact over the wireless network with PCDs performing a second Aversion Alert process, the first Aversion Alert process interacting with the second Aversion Alert process to cause menu items of the restaurant that are compatible with allergy profiles of the PCD users to be displayed on a display device of the PCD.

12. The system of claim 11, wherein if one of the users selects at least one of the displayed menu items, a first order is placed with the restaurant associated for the selected menu item.

13. The system of claim 12, wherein the first order placed with the restaurant includes information describing the allergy profile of the user associated with the first order.

14. The system of claim 13, further comprising:
a first display device in communication with the processor, the first Aversion Alert process performed by the processor causing the first order to be displayed on the first display device.

15. The system of claim 14, further comprising:
a second display device in communication with the processor, the second display device being disposed in a kitchen of the restaurant, the first Aversion Alert process performed by the processor causing the first order to be displayed on the second display device, wherein the first order displayed on the second display device includes information identifying the selected menu item, information identifying the user associated with the first order, and information identifying allergies to which the user associated with the first order is allergic.

16. The system of claim 15, wherein each of the allergy profiles includes a list of items to which the respective user is allergic.

17. The system of claim 16, wherein each of the allergy profiles includes a list of medications for which the respective user has prescriptions.

18. The system of claim 17, wherein each of the allergy profiles includes a list of existing health conditions of the respective user.

19. A method for allowing a user of a personal computing device (PCD) to use the PCD to place food orders with restaurants over a wireless network while preventing or reducing a possibility that a placed food order will contain one or more allergens to which the user is allergic, the method comprising:
in a memory device of the PCD, storing computer instructions and data, the data including at least a first allergy profile of at least the user of the PCD; and
in a processor of the PCD, performing a first Aversion Alert process that:
searches over the wireless network for restaurants having point-of-sale (POS) systems that perform a second Aversion Alert process;
displays only restaurants that have POS terminals that perform the second Aversion Alert process; and
upon the user selecting one of the displayed restaurants, interacting with the second Aversion Alert process to cause menu items of the selected restaurant that are compatible with the first allergy profile to be displayed on a display device of the PCD.

20. The method of claim 19, further comprising:
in a memory device of a first POS system of a first restaurant, storing computer instructions and data, the data including menu items offered by the first restaurant and lists of allergens contained in food items offered by the first restaurant;
in a processor of the first POS system, performing the second Aversion Alert process that interacts over the wireless network with PCDs performing the first Aversion Alert process to cause menu items of the first restaurant that are compatible with allergy profiles of the PCD users to be displayed on respective display devices of the PCDs of the respective users; and
upon receiving a first order corresponding to a selection of at least one of the menu items of the first restaurant by one of the PCD users, displaying on a first display device of the POS terminal in communication with the processor of the POS system the first order, the displayed first order including information describing the allergy profile of the PCD user who made the selection.
